(19) United States
(12) Patent Application Publication
(10) Pub. No.: US 2011/0236293 A1
(43) Pub. Date: Sep. 29, 2011

(54) INTEGRATED GAS REFINERY

(76) Inventors: Stephen Hardman, Hertfordshire (GB); Hui See Yap, Berkshire (GB)

(21) Appl. No.: 12/998,793

(22) PCT Filed: Dec. 10, 2009
(86) PCT No.: PCT/GB2009/002861

§ 371 Date: Jun. 2, 2011

(30) Foreign Application Priority Data
Dec. 11, 2008 (EP) 08253980.0

(51) Int. Cl. C01C 1/04

(52) U.S. Cl. 423/352

(57) ABSTRACT

The present invention relates to an integrated synthesis gas refinery plant and a process for the simultaneous production from a single synthesis gas stream X of a hydrogen stream useful for the production of ammonia, a hydrogen rich synthesis gas stream useful for the production of methanol, and a hydrogen depleted synthesis gas stream useful for the production of hydrocarbons.

The present invention relates to a process for the simultaneous production of a hydrogen stream A useful for the production of product A, a hydrogen rich synthesis gas stream B useful for the production of product B, a hydrogen depleted synthesis gas stream C useful for the production of product C, and optionally a carbon monoxide stream D useful for the production of product D, from a single synthesis gas stream X.

In particular, the present invention relates to an integrated synthesis gas refinery plant and a process for the simultaneous production from a single synthesis gas stream X of a hydrogen stream useful for the production of ammonia, a hydrogen rich synthesis gas stream useful for the production of methanol, a hydrogen depleted synthesis gas stream useful for the production of hydrocarbons like naphtha and diesel, and optionally a carbon monoxide stream useful for the production of acetic acid.

### BRIEF DESCRIPTIONS OF DRAWINGS

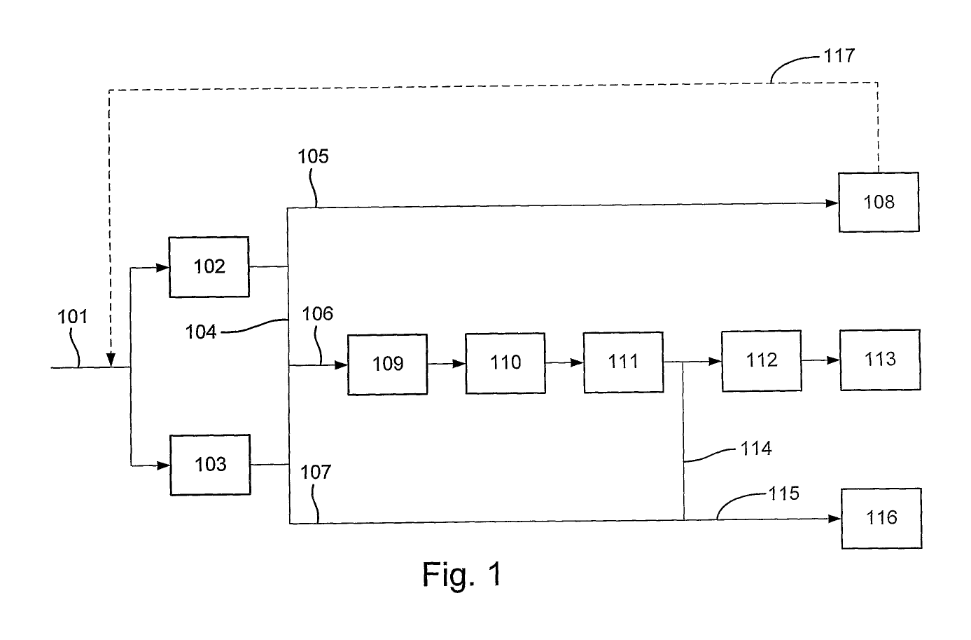

FIG. 1 represents one specific embodiment according to the present invention wherein three products are produced from synthesis gas. In FIG. 1, a process according to the present invention is schematically depicted as follows:
a source of natural gas (101) is introduced into multiple synthesis gas generation reactors (102 & 103) to generate a single synthesis gas source (104), hereinafter referred as the “hydrogen depleted synthesis gas”, used in the downstream operations,
said generated hydrogen depleted synthesis gas (104) is divided into three fractions (105, 106 & 107),
a first fraction of the synthesis gas (105) is used as a synthesis gas source of a gas-to-liquids plant (108) which comprises a Fischer-Tropsch synthesis reaction,
a second fraction of the synthesis gas (106) is subjected to a water gas shift reaction step (109) followed by a CO₂ separation (110), a methanation step (111) and a nitrogen wash step (112); hydrogen produced during this treatment is used as a hydrogen source of an ammonia plant (113),
a third fraction of the synthesis gas (107) is enriched with hydrogen coming from the above second fraction treatment (114) and the resulting enriched hydrogen synthesis gas (115), hereinafter called the “hydrogen rich synthesis gas”, is used as a source of synthesis gas of a methanol plant (116),
optionally, the tail gas stream from the gas-to-liquids plant (117) may be recycled and combined with the natural gas feed introduced to the synthesis gas reactors.

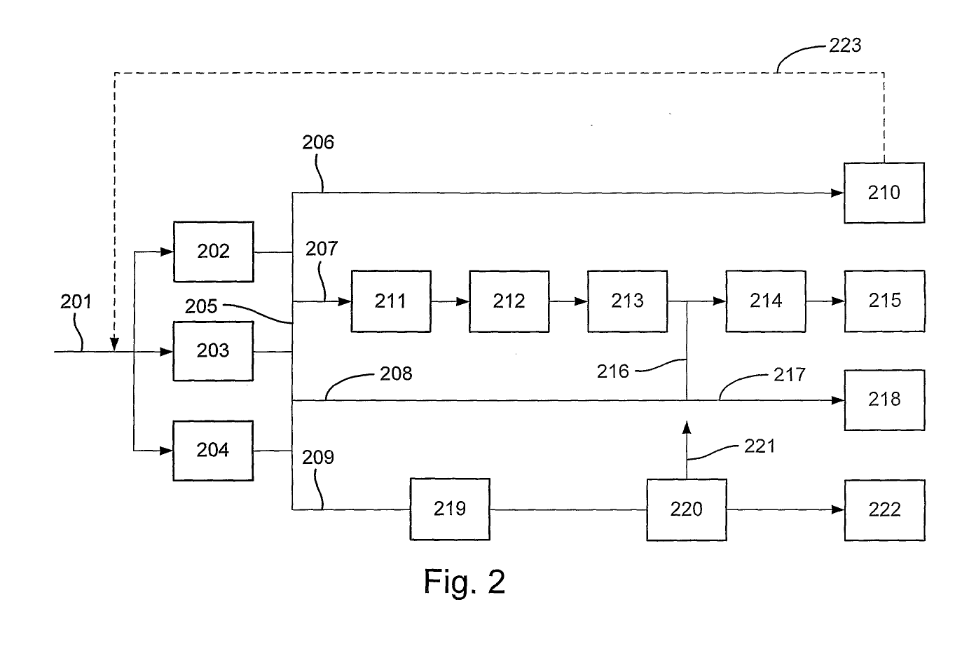

FIG. 2 represents another specific embodiment according to the present invention wherein four products are produced from synthesis gas. In FIG. 2, a process according to the present invention is schematically depicted as follows:
a source of natural gas (201) is introduced into multiple synthesis gas generation reactors (202, 203 & 204) to generate a single synthesis gas source (205), hereinafter referred as the “hydrogen depleted synthesis gas”, used in the downstream operations,
said generated hydrogen depleted synthesis gas (205) is divided into four fractions (206, 207, 208 & 209),
a first fraction of the synthesis gas (206) is used as a synthesis gas source of a gas-to-liquids plant (210) which comprises a Fischer-Tropsch synthesis reaction, a second fraction of the synthesis gas (207) is subjected to a water gas shift reaction step (211) followed by a CO₂ separation (212), a methanation step (213) and a nitrogen wash step (214); hydrogen produced during this treatment is used as a hydrogen source of an ammonia plant (215),
a third fraction of the synthesis gas (208) is enriched with hydrogen coming from the above second fraction treatment (216) and the resulting enriched hydrogen synthesis gas (217), hereinafter called the “hydrogen rich synthesis gas”, is used as a source of synthesis gas of a methanol plant (218),
a fourth fraction of the synthesis gas (209) is subjected to an absorber which removes carbon dioxide (219) and a low temperature separator (220) to obtain a hydrogen rich gas stream (221) and a carbon monoxide stream, which is used as a source of carbon monoxide of an acetic acid plant (222),
optionally, the tail gas stream from the gas-to-liquids plant (223) may be recycled and combined with the natural gas feed introduced to the synthesis gas reactors.

### SUMMARY OF INVENTION

The present invention provides a process for the simultaneous production of a hydrogen stream A useful for the production of product A; a hydrogen rich synthesis gas stream B useful for the production of product B; a hydrogen depleted synthesis gas stream C useful for the production of product C; and optionally, a carbon monoxide stream D useful for the production of product D; from a single synthesis gas stream X characterised in that:
a) the single synthesis gas stream X has a synthesis gas molar ratio calculated as H₂/CO optimized for the production of product C,
b) the single synthesis gas stream X is separated into a synthesis gas stream X1, a synthesis gas stream X2, a synthesis gas stream X3 and optionally a synthesis gas stream X4,
c) the synthesis gas stream X1 is subjected to a water gas shift reaction step to convert the CO from the synthesis gas stream X1 and water into CO₂ and H₂,
d) the CO₂ and H₂ from step c) are respectively separated and recovered,
e) a fraction of the H₂ from step d) is used as the hydrogen stream A,
f) a fraction of the H₂ from step d) is combined with synthesis gas stream X2 which is then used as the hydrogen rich synthesis gas stream B,
g) the synthesis gas stream X3 is used as the hydrogen depleted synthesis gas stream C, and optionally
h) the synthesis gas stream X4 is treated to remove the carbon dioxide and hydrogen thereof; and the resulting carbon monoxide stream is used as a carbon monoxide source of stream D.

### DETAILED DESCRIPTION

According to the present invention, the synthesis gas stream X has a synthesis gas molar ratio calculated as H₂/CO optimized for the production of product C. Therefore, it is clear that the present invention requires in all circumstances that the synthesis gas molar ratio required for the production of chemical C is lower than the synthesis gas molar ratio required for the production of chemical B which is also lower than the synthesis gas molar ratio required for the production of chemical A.

The Applicants have found that by configuring a synthesis gas generation process to meet, within acceptable limits, the lowest synthesis gas molar ratio (H₂/CO) requirement for the production of product C, conditioning of the synthesis gas for processes requiring higher H₂/CO ratio can then be conducted separately, for example by the transformation of water and carbon monoxide to hydrogen and carbon dioxide via the water gas shift reaction. The Applicants have found that this can be highly beneficial as generating hydrogen-rich synthesis gas stream in a separate water shift reaction (as opposed to generating it directly in a steam methane reformer for example) can result in lower overall carbon dioxide (CO₂) emissions.

According to a preferred embodiment of the present invention, the single synthesis gas stream X has a synthesis gas molar ratio calculated as H₂/CO of from 1.6 to 2.5 and preferably from 1.7 to 2.2.

According to one embodiment of the present invention, the single synthesis gas stream X can be generated from any appropriate hydrocarbon feedstock. Said hydrocarbon feedstock used for synthesis gas generation is preferably a carbonaceous material, for example biomass, plastic, naphtha, refinery bottoms, crude synthesis gas (from underground coal gasification or biomass gasification), smelter off gas, municipal waste, coal, and/or natural gas, with coal and natural gas being the preferred sources, and natural gas being the most preferable source.

Natural gas commonly contains a range of hydrocarbons (e.g. C1-C3 alkanes), in which methane predominates. In addition to this, natural gas will usually contain nitrogen, carbon dioxide and sulphur compounds. Preferably the nitrogen content of the feedstock is less than 40 wt %, more preferably less than 10 wt % and most preferably less than 1 wt %.

According to a preferred embodiment of the present invention, the hydrocarbon feedstock may either comprise a single feedstock, or a plurality of independent feedstocks.

According to one embodiment of the present invention, a hydrocarbon feedstock is first fed into at least one synthesis gas generator, having an external heat input, in order to produce a stream comprising essentially carbon oxide(s) and hydrogen (commonly known as synthesis gas) and, depending on the feedstock and process used, one or more of water, unconverted feedstock, nitrogen and inert gas.

Suitable “synthesis gas generation methods” include, but are not limited to, steam reforming (SR), compact reforming (CR), partial oxidation of hydrocarbons (PDX), advanced gas heated reforming (AGHR), microchannel reforming, plasma reforming, autothermal reforming (ATR) and all combinations thereof (regardless of whether the synthesis gas generation methods are operated in series or in parallel).

Synthesis gas generation methods used for producing mixtures of carbon oxide(s) and hydrogen (synthesis gas), in one or more synthesis gas generator(s), are well known. Each of the aforementioned methods has its advantages and disadvantages, and in practice the choice of using a one particular reforming process over another is dictated by economic considerations and/or feedstock availability, as well as obtaining the desired molar ratio of H₂/CO in the synthesis gas. A discussion of the available synthesis gas production technologies is provided in both “Hydrocarbon Processing” V78, N. 4, 87-90, 92-93 (April 1999) and “Petrole et Techniques”, N. 415, 86-93 (July-August 1998).

Processes for obtaining the synthesis gas by catalytic partial oxidation of hydrocarbons (as mentioned above) in a microstructured reactor are exemplified in “IMRET 3: Proceedings of the Third International Conference on Microreaction Technology”, Editor W Ehrfeld, Springer Verlag, 1999, pages 187-196. Alternatively, the synthesis gas may be obtained by short contact time catalytic partial oxidation of hydrocarbonaceous feedstocks as described in EP 0303438.

The synthesis gas can also be obtained via a “Compact Reformer” process as described in “Hydrocarbon Engineering”, 2000, 5, (5), 67-69; “Hydrocarbon Processing”, 79/9, 34 (September 2000); “Today's Refinery”, 15/8, 9 (August 2000); WO 99/02254; and WO 200023689.

According to an embodiment of the present invention, the synthesis gas is generated via at least one steam reforming apparatus (e.g. a steam methane reformer). The steam reforming apparatus configuration is preferably used together with at least one other suitable synthesis gas generator (e.g. an auto-thermal reformer or a partial oxidation apparatus), wherein the said generators are preferably connected in series.

Steam reforming reaction is highly endothermic in nature. Hence, the reaction is commonly catalysed within the tubes of a reformer furnace. When natural gas is chosen as the hydrocarbon feedstock, the endothermic reaction heat that is needed is supplied by burning a fuel (e.g. additional amounts of natural gas or hydrogen). Simultaneous to the steam reforming reaction, the water/gas shift reaction also takes place within the reactor. Since sulphur is a known poison towards the typical catalysts required for the reaction within the steam reformer, the chosen hydrocarbon feedstock is preferably de-sulphurised prior to entering the said reformer.

Additionally, it is desirable to have a high steam to carbon ratio in a steam reformer to prevent carbon from being deposited on the catalyst, and also to ensure high conversion to carbon monoxide; thus, the preferred molar ratio of steam to carbon (i.e. the carbon that is present as hydrocarbons) in a steam reformer is between 1 and 3.5, preferably between 1.2 and 3.

According to another embodiment of the present invention the synthesis gas is generated via a compact reformer. The compact reformer integrates preheating, steam reforming and waste process heat recovery in a single compact unit. The reformer design typically resembles a conventional shell-and-tube heat exchanger that is compact when compared to, for example, a conventional steam methane reformer design configuration. The steam reforming reactions occur within the tubes of the said reactor, which are filled with conventional catalyst. Heat for the endothermic steam reforming reaction is provided on the shellside, where the tubes are heated by combustion of a fuel/air mixture in amongst flames. Heat transfer occurs more efficiently in what is described as a highly countercurrent device. Preferably, the shell side combustion zone also is at elevated pressure. As such elevated pressure is believed to contribute to a more-efficient convective heat transfer to the tubes.

Typically, for commercial synthesis gas production, the pressure at which the synthesis gas is produced ranges from approximately 1 to 100 BAR and preferably from 15 to 55 BAR; and the temperatures at which the synthesis gas exits the final reformer ranges from approximately 650° C. to 1100° C. Typically, high temperatures are necessary in order to produce a favourable equilibrium for synthesis gas production, and to avoid metallurgy problems associated with carbon dusting

According to a preferred embodiment of the present invention, before or during synthesis gas generation, an additional stage may be employed whereby the feedstock is first purified to remove sulphur and other potential catalyst poisons (such as halides or metals e.g. Hg) prior to being converted into synthesis gas. Purification of the synthesis gas, for example by removal of sulphur and the potential catalyst poisons (for subsequent processes in which the systhesis gas is present), can also be performed after synthesis gas preparation, for example, when coal or biomass are used.

As indicated hereinabove, the present invention provides a process for the simultaneous production of a hydrogen stream A useful for the production of product A; a hydrogen rich synthesis gas stream B useful for the production of product B; a hydrogen depleted synthesis gas stream C useful for the production of product C; and optionally, a carbon monoxide stream D useful for the production of product D; from a single synthesis gas stream X.

In one embodiment of the present invention, the process does not comprise the optional production of the carbon monoxide stream D from the optional synthesis gas stream X4. Thus, the present invention provides a process for the simultaneous production of a hydrogen stream A useful for the production of product A; a hydrogen rich synthesis gas stream B useful for the production of product B; a hydrogen depleted synthesis gas stream C useful for the production of product C; from a single synthesis gas stream X characterised in that:
a) the single synthesis gas stream X has a synthesis gas molar ratio calculated as H₂/CO optimized for the production of product C,
b) the single synthesis gas stream X is separated into a synthesis gas stream X1, a synthesis gas stream X2 and a synthesis gas stream X3,
c) the synthesis gas stream X1 is subjected to a water gas shift reaction step to convert the CO from the synthesis gas stream X1 and water into CO₂ and H₂,
d) the CO₂ and H₂ from step c) are respectively separated and recovered,
e) a fraction of the H₂ from step d) is used as the hydrogen stream A,
f) a fraction of the H₂ from step d) is combined with synthesis gas stream X2 which is then used as the hydrogen rich synthesis gas stream B, and
g) the synthesis gas stream X3 is used as the hydrogen depleted synthesis gas stream C.

According to a preferred embodiment of the present invention, product A is ammonia; product B is methanol; product C is a hydrocarbon mixture. Preferably, the hydrocarbon mixture comprises naphtha and/or diesel, or components thereof. For producing ammonia as product A, nitrogen is combined with the hydrogen stream A of hereinabove step e).

In another embodiment of the present invention, the process does comprise the optional production of the carbon monoxide stream D from the optional synthesis gas stream X4. Thus, the present invention also provides a process for the simultaneous production of a hydrogen stream A useful for the production of product A; a hydrogen rich synthesis gas stream B useful for the production of product B; a hydrogen depleted synthesis gas stream C useful for the production of product C; and a carbon monoxide stream D, useful for the production of product D; from a single synthesis gas stream X characterised in that:
a) the single synthesis gas stream X has a synthesis gas molar ratio calculated as H₂/CO optimized for the production of product C,
b) the single synthesis gas stream X is separated into a synthesis gas stream X1, a synthesis gas stream X2, a synthesis gas stream X3 and a synthesis gas stream X4,
c) the synthesis gas stream X1 is subjected to a water gas shift reaction step to convert the CO from the synthesis gas stream X1 and water into CO₂ and H₂,
d) the CO₂ and H₂ from step c) are respectively separated and recovered,
e) a fraction of H₂ recovered from step d) is used as the hydrogen stream A,
f) a fraction of the H₂ from step d) is combined with synthesis gas stream X2 which is then used as the hydrogen rich synthesis gas stream B,
g) the synthesis gas stream X3 is used as the hydrogen depleted synthesis gas stream C, and
h) the synthesis gas stream X4 is treated to remove the carbon dioxide and hydrogen thereof; and the resulting carbon monoxide stream is used as a carbon monoxide source of stream D.

According to a preferred embodiment of the present invention, product A is ammonia; product B is methanol; product C is a hydrocarbon mixture; and product D is acetic acid. Preferably, the hydrocarbon mixture comprises naphtha and/or diesel, or components thereof. For producing ammonia as product A, nitrogen is combined with the hydrogen stream A of hereinabove step e).

According to an embodiment of the present invention, the hydrogen recovered from hereinabove step h) can also advantageously be used as either a fraction of the source of hydrogen for the hydrogen stream A and/or as a fraction of the source of hydrogen for the hydrogen rich synthesis gas stream B.

According to an additional embodiment of the present invention, a fraction of the hydrogen stream A and/or a fraction of the hydrogen recovered from hereinabove step h) can also advantageously be exported for sale.

As indicated hereinabove, a part of the synthesis gas stream (X1) is subjected to a water gas shift reaction step to convert the CO from the said synthesis gas stream (X1) and water (steam) into CO₂ and H₂. This water gas shift reaction step consists of adding steam to the synthesis gas stream (X1) and subjecting the resulting mixture to a water gas-shift reaction step, in order to convert a majority of the CO present, into CO₂ and H₂, this step usually leaves some residual amount of CO in the synthesis gas stream, typically about 0.3% by volume. This is followed by CO₂ removal to obtain a hydrogen stream with a much reduced carbon dioxide content.

It is known that any remaining oxygen bearing compounds (CO and CO₂) in the hydrogen stream can be poisonous towards ammonia synthesis catalyst; said compounds are thus preferably removed from the hydrogen stream, e.g. by using a methanator. Said methanator can convert these residual carbon oxides to methane and water. The methanated synthesis gas (hydrogen) stream is then preferably cooled and transferred to a nitrogen wash system where methane is separated. Said nitrogen preferably comes from an air separation unit and it is preferably added to the hydrogen stream at an appropriate stoichiometric ratio for an ammonia synthesis unit, i.e. a molar ratio of H₂/N₂ of about 2.5 to 3.5. The recovered CO₂ can be sequestrated. The recovered H₂ can then be used as feedstock to an ammonia plant and also as a feedstock to a methanol plant.

As indicated above, the water gas shift reaction is used to convert carbon monoxide to carbon dioxide and hydrogen through a reaction with steam e.g.

CO+H₂O=CO₂+H₂

The reaction is exothermic, which means the equilibrium shifts to the right at lower temperatures conversely at higher temperatures the equilibrium shifts in favour of the reactants. Conventional water gas shift reactors use metallic catalysts in a heterogeneous gas phase reaction with CO and steam. Although the equilibrium favours formation of products at lower temperatures the reaction kinetics are faster at elevated temperatures. For this reason the catalytic water gas shift reaction is initially carried out in a high temperature reactor at 350-370° C. and this is followed frequently by a lower temperature reactor typically 200-220° C. to improve the degree of conversion The conversions of CO are typically 90% in the first reactor and a further 90% of the remaining CO is converted in the low temperature reactor, when one is used. Other non metallic catalysts, such as oxides, and mixed metal oxides, such as Cu/ZnO, are known to catalyse the water gas shift reaction. The degree of conversion of the CO can also be increased by adding more than the stoichiometric amount of steam but this incurs an additional heat penalty. Methane and nitrogen are inert under typical water gas shift conditions.

In the hydrogen production, carbon dioxide (CO₂) is an unavoidable by-product of the synthesis gas generation step (regardless of whether the route used is natural gas steam reforming, hydrocarbon partial oxidation, or coal gasification), which is preferably separated before further downstream processing. Virtually all commercial processes for CO₂ separation are based on absorption in liquid solvents. The solvents used may be categorized into two types—chemical solvents (such as aqueous solutions of monoethanolamine or potassium carbonate, where the mechanism of absorption is via a reversible chemical reaction) or physical solvents (such as methanol used in “Rectisol” or dimethyl ethers of polyethylene glycols used in “Selexol”, where the absorption of CO₂ and other acid gases is without chemical reactions). The solvents typically contain an activator to promote mass transfer. It is possible to remove carbon dioxide to less than 1000 ppm in many absorption systems. Trace amounts of carbon oxides can be are removed by methanation as mentioned below.

CO+3H₂ [symbol] CH₄+H₂O

CO₂+4H₂ [symbol] CH₄+2H₂O

Following CO₂ removal, any remaining carbon oxides (e.g. CO, CO₂) can be converted in a methanator by reaction with H₂ to methane and water by passing the gas over an iron or nickel catalyst. Carbon oxides are preferably reduced to trace levels because they can act as ammonia synthesis catalyst poisons. The main methanation reactions are highly exothermic and are favored by low temperatures and high pressures. The reaction rate increases both with increased temperature and pressure. Carbon deposition can occur during methanation. However, with the large excess of hydrogen in synthesis gas, no problems in carbon formation are usually encountered. Very low carbon oxide levels (<10 ppm) can be produced by methanation. The disadvantage of methanation is that hydrogen is consumed; therefore the process is preferably used for low levels (e.g. ≦1 mol %, preferably ≦1,000 ppm), such as residual carbon oxides following, CO₂ removal, of carbon dioxides. Typically, the methanated hydrogen stream is then cooled and dried to remove traces of water over alumina or molecular sieves before further use, e.g. before entering a nitrogen wash stage.

The stoichiometry for ammonia synthesis from hydrogen and nitrogen is:

3 H₂+N₂ [symbol] 2 NH₃

In addition, since the synthesis reaction is equilibrium controlled and conversion per pass is low, the synthesis typically requires a large recycle. Inert impurities can lower the efficiency of ammonia synthesis since large purge streams are typically removed to avoid accumulation of impurities in the recycle loop. Cryogenic washing with liquid nitrogen can be used to remove methane and argon to very low levels.

Following any necessary purification, the hydrogen stream can be compressed and passed to an ammonia converter where hydrogen and nitrogen chemically combine over a catalyst to produce ammonia. All commercial processes for the manufacture of ammonia depend on the equilibrium between hydrogen and nitrogen reactants and ammonia product, as shown in the reaction above. This reaction towards ammonia is favored by increased pressure and decreased temperatures. At a given temperature and pressure, the ammonia concentration decreases linearly with an increasing concentration of inerts. Equilibrium is also affected by the hydrogen-nitrogen ratio.

Whilst the equilibrium indicates that conversion of hydrogen and nitrogen to ammonia increases continuously with pressure, the optimum synthesis pressure in current ammonia plant design is within the range of 150-375 atm. The catalyst is commonly based on iron, which may be promoted with aluminum, potassium and/or calcium. A wide variety of ammonia synthesis designs are available and they are described in the literature.

Conversion efficiency (i.e. the ratio of actual ammonia in the gas to that theoretically possible under the operating conditions) increases with increasing temperature. However, above 480-550° C., iron catalysts can begin to deteriorate and some cooling means would typically be used to prevent overheating. Depending to some degree on the catalyst, the normal catalyst inlet temperature in most commercial converters is about 400° C. and the maximum hot spot temperature allowed is not above 525° C. The composition of the hydrogen/nitrogen stream plays an important part in determining the conversion. Conversion efficiency is dependent on the ratio of hydrogen to nitrogen and rate of conversion increases with increasing pressure. However, conversion efficiency has been found to decrease some 15-20% when pressure was increased from 151 to 317 atm.

According to the present invention, a fraction of the hydrogen stream separated and recovered from the treatment of the synthesis gas stream X1 is combined with synthesis gas stream X2 which is then used as the hydrogen rich synthesis gas stream B. According to a preferred embodiment of the present invention, the resulting hydrogen rich synthesis gas stream is then introduced into a methanol synthesis unit, in order to produce a stream comprising methanol.

Preferably, the Sₙ (stoichiometric number) molar ratio, (H₂—CO₂):(CO+CO₂), of said hydrogen rich synthesis gas stream B is greater than 1.6, more preferably greater than 1.8 and most preferably greater than 2.0. Preferably the Sₙ molar ratio, (H₂—CO₂):(CO+CO₂), of said hydrogen rich synthesis gas stream B is less than 3.0, more preferably less than 2.5 and most preferably less than 2.2. The synthesis of methanol typically requires a composition of the synthesis gas with a stoichiometric number of between 2.0 to 2.15, and is preferably 2.08, a carbon dioxide concentration typically in the range between 2 and 8% by volume and a nitrogen concentration typically of less than 0.5% by volume.

The methanol synthesis unit may be any unit that is suitable for producing methanol, for example a fixed bed reactor, which can be run with or without external heat exchange equipments e.g. a multi-tubular reactor; or a fluidised bed reactor; or a void reactor.

Preferably the methanol synthesis unit is operated at a temperature of greater than 200° C., more preferably greater than 220° C. and most preferably greater than 240° C.; and preferably less than 310° C., more preferably less than 300 ° C. and most preferably less than 290° C. Preferably, the methanol synthesis unit is operated at pressure of greater than 2 MPa and most preferably greater than 5 MPa; and preferably less than 10 MPa and most preferably less than 9 MPa. Since methanol synthesis is an exothermic reaction, the chosen temperature of operation is typically governed by a balance of promoting the forward reaction and increasing the rate of conversion

The catalysts used for methanol synthesis can typically be divided into 2 groups:
i. the high pressure zinc catalysts, composed of zinc oxide and a promoter; and
ii. low pressure copper catalysts, composed of zinc oxide, copper oxide and a promoter.

The preferred methanol synthesis catalyst is a mixture of copper, zinc oxide, and a promoter such as, chromia or alumina.

The hydrogen depleted synthesis gas stream C may conveniently be used for the production of hydrocarbon products by the Fischer-Tropsch synthesis reaction, for example in a gas-to-liquid plant. Advantageously, the hydrogen depleted synthesis gas stream C may be used to produce liquid hydrocarbon fuels such as diesel fuels and naphtha.

Typically, production of liquid fuels using Fischer Tropsch synthesis comprises three discrete steps. In the first step, a hydrocarbon feed (e.g. natural gas, coal, biomass or waste) is converted to synthesis gas. Synthesis gas is then fed to a second stage to be converted to a hydrocarbon composition, such as a composition containing paraffinic wax and light hydrocarbons, via the Fischer-Tropsch synthesis reaction. The hydrocarbon composition, typically as liquid streams, is then passed to a third step, where it is hydrocracked and distilled to produce the final products.

The following is a general Fischer-Tropsch synthesis reaction:

[CO+2H₂]ₙ+H₂→CH₃(CH₂)ₙ₋₂CH₃+nH₂O

CO+3H₂→CH₄+H₂O

CO+H₂O→CO₂+H₂

Unwanted side reactions can result in the formation of methane and carbon dioxide. There are reaction paths other than the straightforward chain addition. Olefins, alcohols and short chain aldehydes can also be formed.

The synthesis of Fischer-Tropsch products requires a typical composition of the synthesis gas with a H₂:CO ratio of 1.6 to 2.5. The Fischer-Tropsch synthesis reactor typically entails the conversion of synthesis gas with cobalt or iron based catalyst to produce paraffinic hydrocarbons e.g wax and light hydrocarbons and one equivalent of water per carbon atom of product. The reaction is highly exothermic, and poor temperature control can lower the selectivity to higher paraffins.

In the third step described above, long chain molecules, e.g. in the wax and hydrocarbon liquids are isomerised and cracked into shorter molecules using hydrocracking catalyst. The reaction consists of two steps, cracking of large wax molecules into chains of approximately similar length, and their isomerisation into methyl isomers. The reaction rate for cracking depends on the chain length, so shorter chain straight run product may be relatively unaffected by passing through a hydrocracker. Oxygenate compounds may also react to form paraffins and water.

The stream from the hydrocracker can be separated in a fractionator into final hydrocarbon products, e.g. diesel and naptha, with any unconverted wax typically being recycled to the hydrocracker.

Any tail gas from the Fischer-Tropsch synthesis reaction, e.g. unconverted synthesis gas and highly volatile hydrocarbon molecules, may conveniently be recycled to a synthesis gas generation unit, or may be combined with the feed stream to a synthesis gas generation unit.

1. A process for the simultaneous production of a hydrogen stream A useful for the production of product A; a hydrogen rich synthesis gas stream B useful for the production of product B; a hydrogen depleted synthesis gas stream C useful for the production of product C; and optionally, a carbon monoxide stream D useful for the production of product D; from a single synthesis gas stream X characterised in that:
a) the single synthesis gas stream X has a synthesis gas molar ratio calculated as H₂/CO optimized for the production of product C,
b) the single synthesis gas stream X is separated into a synthesis gas stream X1, a synthesis gas stream X2, a synthesis gas stream X3 and optionally a synthesis gas stream X4,
c) the synthesis gas stream X1 is subjected to a water gas shift reaction step to convert the CO from the synthesis gas stream X1 and water into CO₂ and H₂,
d) the CO₂ and H₂ from step c) are respectively separated and recovered,
e) a fraction of the H₂ from step d) is used as the hydrogen stream A,
f) a fraction of the H₂ from step d) is combined with synthesis gas stream X2 which is then used as the hydrogen rich synthesis gas stream B,
g) the synthesis gas stream X3 is used as the hydrogen depleted synthesis gas stream C, and optionally
h) the synthesis gas stream X4 is treated to remove the carbon dioxide and hydrogen thereof; and the resulting carbon monoxide stream is used as a carbon monoxide source of stream D.

2. A process according to claim 1, wherein the process does not comprise the optional production of the carbon monoxide stream D from the optional systhesis gas stream X4.

3. A process according to claim 2, wherein product A is ammonia; product B is methanol; product C is a hydrocarbon mixture.

4. A process according to claim 1, wherein the process comprises the optional production of the carbon monoxide stream D from the optional synthesis gas stream X4.

5. A process according to claim 4, wherein product A is ammonia;
product B is methanol; product C is a hydrocarbon mixture; and product D is acetic acid.

6. A process according to claim 4, wherein the hydrogen recovered from step h) is used as a fraction of the source of hydrogen for the hydrogen stream A and/or as a fraction of the source of hydrogen for the hydrogen rich synthesis gas stream B.

7. A process according to claim 1, wherein the single synthesis gas stream X has a synthesis gas molar ratio calculated as H₂/CO of from 1.6 to 2.5.

8. A process according to claim 1, wherein the Sn molar ratio, (H₂—CO₂):(CO+CO₂), of the hydrogen rich synthesis gas stream B is greater than 1.6.

9. A process according to claim 1, wherein the Sn molar ratio, (H₂—CO₂):(CO+CO₂), of the hydrogen rich synthesis gas stream B is less than 3.0.
